(19) United States
(12) Patent Application Publication
(10) Pub. No.: US 2014/0112236 A1
(43) Pub. Date: Apr. 24, 2014

(54) APPARATUS AND METHOD FOR TRANSMITTING CONTROL INFORMATION FOR CONTINUOUS MBMS SERVICE

(71) Applicants: Myung Cheul Jung, Seoul (KR); Ki Bum Kwon, Seoul (KR); Jae Hyun Ahn, Seoul (KR)

(72) Inventors: Myung Cheul Jung, Seoul (KR); Ki Bum Kwon, Seoul (KR); Jae Hyun Ahn, Seoul (KR)

(73) Assignee: Pantech Co., Ltd, Seoul (KR)

(21) Appl. No.: 14/114,579

(22) PCT Filed: Apr. 30, 2012
(86) PCT No.: PCT/KR2012/003367

§ 371 Date: Oct. 29, 2013

(30) Foreign Application Priority Data
May 2, 2011 (KR) 10-2011-0041535

(51) Int. Cl. H04W 36/00; H04W 4/06

(52) U.S. Cl. CPC H04W 36/0072; H04W 4/06
USPC 370/312

(57) ABSTRACT

The present specification discloses an apparatus and a method for transmitting control information for a continuous MBMS service. The present specification discloses a terminal comprising: a terminal processor for generating a measurement report related to source and target cells, reconfiguring RRC connections on the basis of an RRC connection reconfiguration message, and generating an RRC reconfiguration completion message comprising a flag indicating whether or not the MBMS service has been received and/or active MBMS service information indicating the type of MBMS service; a terminal transmission part for transmitting the measurement report to the source base station and the RRC connection reconfiguration completion message to the target base station; and a terminal reception part for receiving the RRC connection reconfiguration message from the source base station.

### CROSS-REFERENCE TO RELATED APPLICATIONS

This application is the National Stage Entry of International Application PCT/KR2012/003367, filed on Apr. 30, 2012, and claims priority from and the benefit of Korean Patent Application No. 10-2011-0041535, filed on May 2, 2011, both of which are incorporated herein by reference in their entireties for all purposes as if fully set forth herein.

### BACKGROUND

1. Field

The present invention relates to wireless communication and, more particularly, to an apparatus and method for transmitting control information for continuity of an MBMS service.

2. Discussion of the Background

Also, cellular is a concept proposed to overcome limitations in service areas and capacity for accommodating frequencies and subscribers. It is a scheme of providing call coverage by changing a high output single base station (BS) into a plurality of low output BSs. Namely, a mobile communication service area is divided into several small cell units, and different frequencies are allocated to adjacent cells and the same frequency band is used in two cells which are sufficiently distant from each other without interference to thus allow for reuse of a frequency spatially.

Handover or handoff refers to a function allowing a terminal to be automatically tuned with a new traffic channel of an adjacent communication service area (hereinafter, referred to as a ‘target cell’) to continuously maintain a call state as the terminal moves to be released from a current communication service area (hereinafter, referred to as a ‘source cell’). Namely, when signal strength of a terminal which communicates with a particular BS weakens in the particular BS (referred to as a ‘source BS’), the terminal is linked to an adjacent BS (referred to as a ‘target BS’). When handover is performed, a call disconnection made as a terminal moves to an adjacent cell can be solved.

An MBMS (Multimedia Broadcast/Multicast Service) is a service of simultaneously transmitting data packets to a plurality of users like an existing CBS (Cell Broadcast Service). However, the CBS is a low speed message-based service, while the MBMS aims at transmitting multimedia data at a high speed. Also, the CBS is not an IP (Internet Protocol)-based service, while the MBMS is based on IP multicast. The MBMS is advantageous in that, when a certain amount of users exist in the same cell, required resource (or a channel) is shared in case of transmission to the users to thereby allow the plurality of users to is receive the same multimedia data, thus increasing efficiency of radio resource and allowing the user to use a multimedia service at low cost.

According to the MBMS, in order to allow a plurality of terminals to effectively receive data in a single service, a common channel called a multicast channel is used. Namely, over a single service data, dedicated channels corresponding to the amount of terminals that want to receive the service are not allocated but only a single common channel is allocated. Since a plurality of terminals simultaneously receive the common channel, efficiency of radio resource is increased.

### SUMMARY

The present invention provides an apparatus and method for transmitting control information for continuity of an MBMS service.

The present invention also provides an apparatus and method for providing continuity of an MBMS service by using a handover procedure.

The present invention also provides an apparatus and method for providing continuity of an MBMS service by using an RRC connection reconfiguration procedure.

The present invention also provides a terminal reporting whether the terminal receives an MBMS service and a type of a received MBMS service to a source base station (BS) or a target BS.

The present invention also provides a source BS and a target BS providing continuity of an MBMS service with respect to a terminal.

In an aspect, a terminal (or user equipment (UE)), which transmits control information for continuity of a multimedia broadcast multicast service (MBMS) service, as a is terminal performing handover from a source base station (BS) (or a source eNB) to a target BS (or a target eNB) is provided. The UE includes: a UE processor configured to generate a measurement report regarding a source cell and a target cell, reconfigure a radio resource control (RRC) connection on the basis of an RRC connection reconfiguration message, and generate an RRC connection reconfiguration complete message including at least one of a flag indicating whether an MBMS service is received and active MBMS service information indicating a type of the MBMS service; a UE transmission unit configured to transmit the measurement report to the source BS and transmit the RRC connection reconfiguration complete message to the target BS; and a UE reception unit configured to receive the RRC connection reconfiguration message from the source BS.

In an aspect, a method for transmitting control information for continuity of a multimedia broadcast multicast service (MBMS) service by a UE which performs handover from a source base station (BS) to a target BS. The method includes: generating a measurement report regarding a source cell and a target cell; transmitting the measurement report to the source BS; receiving a radio resource control (RRC) connection reconfiguration message from the source BS; reconfiguring an RRC connection on the basis of the RRC connection reconfiguration message; generating an RRC connection reconfiguration complete message including at least one of a flag indicating whether an MBMS service is received and active MBMS service information indicating a type of the MBMS service; and transmitting the RRC connection reconfiguration complete message to the target BS.

In another aspect, a target base station (BS) providing continuity of a multimedia broadcast multicast service (MBMS) service with respect to a terminal (or user equipment (UE)) is provided. The target BS includes: a target processor configured to generate an MBMS is information request message for requesting at least one of information regarding whether the UE receives an MBMS service, information regarding a type of the MBMS service, and information regarding a cell in which the MBMS service is transmitted, from the UE, and generate an MBMS point-to-multipoint (PTM) radio bearer (RB) (MRB) initiation message indicating that the target BS provides the MBMS service through an MRB as a bearer for an MBMS; a target transmission unit configured to transmit the MBMS information request message or the MRB initiation message to the UE; and a target reception unit configured to receive an MBMS information response message including at least one of information regarding whether the UE receives an MBMS service, information regarding a type of the MBMS service, information regarding a cell in which the MBMS service is transmitted, information regarding a component carrier (CC) in which the MBMS service is transmitted, and information regarding at least one of a primary serving cell PCell and a secondary serving cell SCell in which the MBMS service is received, in case of a UE available for carrier aggregation (CA), from the UE as a response with respect to the MBMS information request message.

In another aspect, a method for providing continuity of a multimedia broadcast multicast service (MBMS) service by a target base station (BS) with respect to a UE. The method includes: transmitting an MBMS information request message for requesting at least one of information regarding whether the UE receives an MBMS service, information regarding a type of the MBMS service, and information regarding a cell in which the MBMS service is transmitted from the UE to the UE; receiving an MBMS information response message including at least one of information regarding whether the UE receives an MBMS service, information regarding a type of the MBMS service, and information regarding a cell in which the MBMS service is transmitted, from the UE as a response with respect to the MBMS information request is message; and transmitting an MBMS point-to-multipoint (PTM) radio bearer (RB) (MRB) initiation message indicating that the target BS provides the MBMS service through an MRB as a bearer for an MBMS, to the UE.

According to embodiments of the present invention, a UE, which is receiving an MBMS service, can continuously receive the MBMS service even after the UE performs handover to a target BS, and continuity of the MBMS service is guaranteed for the UE.

### BRIEF DESCRIPTION OF THE DRAWINGS

FIG. 1 is a block diagram illustrating a wireless communication system.

FIG. 2 is a block diagram illustrating a radio protocol architecture with respect to a user plane and a radio protocol architecture with respect to a control plane.

FIG. 3 is a view illustrating mapping between downlink logical channels and downlink physical channels.

FIG. 4 is a view illustrating mapping between downlink transport channels and downlink physical channels.

FIG. 5 is a view illustrating a structure of a core network for an MBMS to which the present invention is applied.

FIG. 6 is a view illustrating an example of a general scenario to which a handover method for continuity of a service in an MBMS according to an embodiment of the present invention.

FIG. 7 is a flow chart illustrating a method for transmitting control information for continuity of an MBMS service according to an example of the present invention.

FIG. 8 is a flow chart illustrating a method for transmitting control information is for continuity of an MBMS service according to another example of the present invention.

FIG. 9 is a flow chart illustrating a method for transmitting control information for continuity of an MBMS service according to another example of the present invention.

FIG. 10 is a flow chart illustrating an operation of a terminal that receives an MBMS service according to an example of the present invention.

FIG. 11 is a flow chart illustrating an operation of a source base station (BS) that receives an MBMS service according to an example of the present invention.

FIG. 12 is a flow chart illustrating an operation of a target BS that receives an MBMS service according to an example of the present invention.

FIG. 13 is a block diagram illustrating a terminal, a source BS and a target BS according to an embodiment of the present invention.

### DETAILED DESCRIPTION OF THE ILLUSTRATED EMBODIMENTS

Hereinafter, embodiments of the present invention will be described with reference to the accompanying drawings, in which like numbers refer to like elements throughout although they are shown in different drawings. In describing the present invention, if a detailed explanation for a related known function or construction is considered to unnecessarily divert the gist of the present invention, such explanation will be omitted but would be understood by those skilled in the art.

In the present disclosure, a wireless communication network will be described, and an operation performed in the wireless communication network may be performed in a process of controlling a network and transmitting data by a system (e.g., a base station (BS)) administering the corresponding wireless communication network or may be performed in a terminal (or user equipment (UE)) connected to the corresponding wireless network.

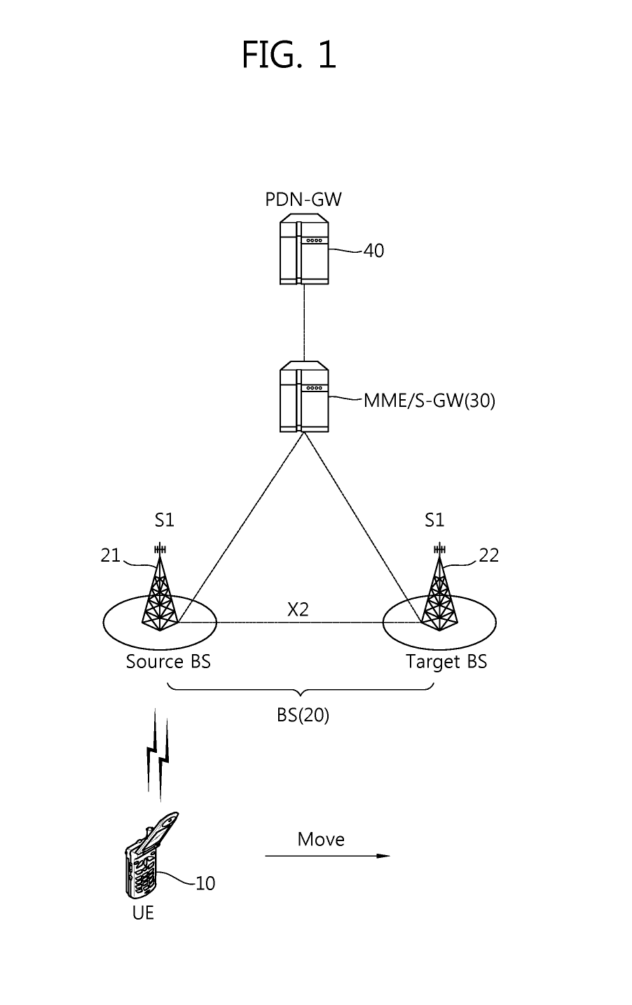

FIG. 1 is a block diagram illustrating a wireless communication system. The wireless communication system may have a network architecture of an evolved-universal mobile telecommunications system (E-UMTS). The E-UMTS system may be a long term evolution (LTE) or an LTE-advanced (LTE-A) system. The wireless communication system is widely disposed to provide a variety of communication services such as voice data, packet data, and the like.

Multi-access schemes applied to the wireless communication system are not limited. Namely, various multi-access schemes such as CDMA Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA, or the like, may be used.

Here, for uplink transmission and downlink transmission, a TDD (Time Division Duplex) scheme in which transmission is made by using a different time or an FDD (Frequency Division Duplex) scheme in which transmission is made by using different frequencies may be used.

Referring to FIG. 1, an E-UTRAN (Evolved-UMTS Terrestrial Radio Access Network) includes at least one BS 20 providing a control plane and a user plane. A terminal (or a UE) 10 may be fixed or mobile and may be called by other names such as mobile station (MS), advanced MS (AMS), user terminal (UT), subscriber station (SS), wireless device, or the like.

The BS 20 generally refers to a station that communicates with the UE 10 and may be called by other names such as evolved NodeB (eNB), base transceiver system (BTS), access point (AP), femto-eNB, pico-eNB, home eNB, relay, and the like. The BS 20 may provide is at least one cell to a terminal. A cell may refer to a geographical area providing a communication service or may refer to a particular frequency band. A cell may refer to a combination of uplink frequency resource and optional uplink frequency resource. Also, when carrier aggregation (CA) is not considered generally, uplink and downlink frequency resources exist as a pair all the time in a single cell.

An interface for user traffic or control traffic transmission may be used between BSs 20. A source BS 21 refers to a base station with which a radio bearer is configured with the current terminal 10, and a target BS 22 refers to a BS to which the UE 10 wants to cut off the radio bearer with the source BS 21 and perform handover to newly configure a radio bearer.

The BSs 20 may be connected through an X2 interface. The X2 interface may be used for exchanging messages between the BSs 20. The BSs 20 are connected to an evolved packet system (EPS), specifically, a mobility management entity (MME)/serving gateway (S-GW) 30, through an S1 interface. The S1 interface supports a many-to-many relationship between the BSs 20 and the MME/S-GW 30. In order to provide a packet data service to the MME/S-GW 30, a PDN-GW 40 is used. The PDN-GW 40 differs according to the purpose of communication or a service, and the PDN-GW 40 supporting a particular service may be searched by using access point name (APN) information.

Inter-E-UTRAN handover is a basic handover mechanism used for handover between E-UTRAN access networks, which includes X2-based handover and S1-based handover. The X2-based handover is used when a UE wants to perform handover to the target BS 22 from the source BS 21 by using the X2 interface, and in this case, the MME/S-G2 30 is not changed.

Due to the S1-based handover, the first bearer configured among the P-GW 40, is the MME/S-GW 30, the source BS 21, and the UE 10 is released, and a second bearer is newly configured among the P-GW 40, the MME/S-GW 30, the target BS 22, and the UE 10.

Hereinafter, downlink refers to communication from the BS 20 to the UE 10 and uplink refers to communication from the UE 10 to the BS 20. Downlink may also be referred to as a forward link, and uplink may also be referred to as a reverse link. In downlink, a transmitter may be part of the BS 20 and a receiver may be part of the UE 10. In uplink, a transmitter may be part of the UE 10 and a receiver may be part of the BS 20.

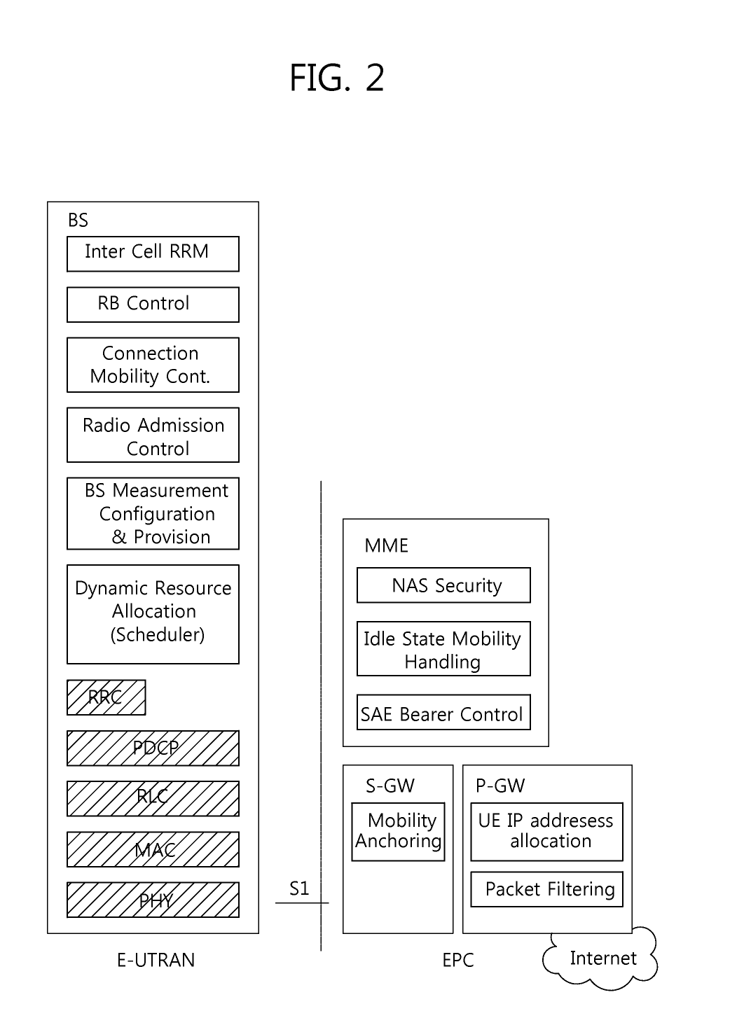

FIG. 2 is a block diagram showing a radio protocol architecture for a user plane, and a radio protocol architecture for a control plane. The data plane is a protocol stack for user data transmission. The control plane is a protocol stack for control signal transmission.

Referring to FIG. 2, a physical (PHY) layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface. Between different PHY layers, i.e., a PHY layer of a transmitter and a PHY layer of a receiver, data is transferred through the physical channel. There are some physical control channels. A physical downlink control channel (PDCCH) provides information regarding resource allocation of a paging channel (PCH) and a downlink shared channel (DL-SCH) and hybrid automatic repeat request (HARQ) information regarding the DL-SCH. The PDCCH may carry uplink scheduling grant informing the UE about resource allocation of uplink transmission. A physical control format indicator channel (PCFICH) may inform the UE about the amount of OFDM symbols used for PDCCHs and may is be transmitted at every subframe. A PHICH (physical Hybrid ARQ Indicator Channel) carries an HARQ ACK/NAK signal as a response to an uplink transmission. A PUCCH (Physical uplink control channel) carries a HARQ ACK/NAK signal with respect to a downlink transmission, a scheduling request, and uplink control information such as CQI, or the like. A PUSCH (Physical uplink shared channel) carries an UL-SCH (uplink shared channel).

Functions of the MAC layer include mapping between a logical channel and a transport channel and multiplexing/demultiplexing on a transport block provided to a physical channel over a transport channel of a MAC service data unit (SDU) belonging to the logical channel. The MAC layer provides a service to a radio link control (RLC) layer through the logical channel. The logical channel may be divided into a control channel for transmitting control region information and a traffic channel for transmitting user region information.

Functions of the RLC layer include RLC SDU concatenation, segmentation, and reassembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer serves to control the logical channel, the transport channel, and the physical channel in association with configuration, reconfiguration and release of radio bearers (RBs). An RB is a logical path provided by the first layer (i.e., the PHY layer) and the second layer (i.e., the MAC layer, the RLC layer, and the PDCP layer) for is data delivery between the UE and the network. The setup of the RB implies a process for specifying a radio protocol layer and channel properties to provide a particular service and for determining respective detailed parameters and operations. The RB can be classified into a signaling RB (SRB), a data RB (DRB), and an MBMS point-to-multipoint (PTM) RB (MRB). The SRB is used as a path for transmitting an RRC message in the control plane. The DRB is used as a path for transmitting user data in the user plane. The MRB is used as a path for transmitting MBMS data.

The non-access stratum (NAS) layer positioned in an upper layer of the RRC layer may serve to perform a session management, mobility management, and the like.

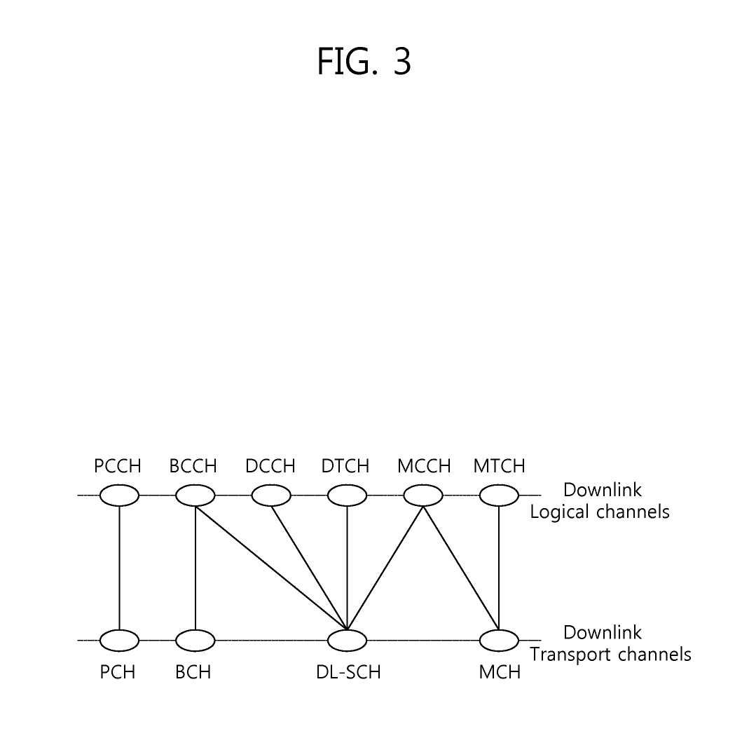

FIG. 3 illustrates mapping between downlink logical channels and downlink transport channels.

Referring to FIG. 3, a paging control channel (PCCH) is mapped to a paging channel (PCH), and a broadcast control channel (BCCH) is mapped to a broadcast channel (BCH) or a downlink shared channel (DL-SCH). A common control channel, a dedicate control channel (DCCH), a dedicated traffic channel (DTCH), a multicast control channel (MCCH), and a multicast traffic channel (MTCH) are mapped to the DL-SCH. The MCCH and the MTCH are mapped to a multicast channel (MCH).

Each logical channel type is defined according to which type of information is transmitted. A logical channel includes two types of control channel and traffic channel.

The control channel is used to transmit control plane information. The BCCH is a downlink channel for broadcasting system control information. The PCCH is a downlink channel for transmitting paging information, which is used by a network when it does not know a location of a UE. The CCCH is a channel for transmitting control information between a UE and a network, which is used by a UE when there is no RRC connection with a network. The MCCH is a point-to-multipoint downlink channel used to transmit MBMS control information, and used for UEs that receive MBMS. The DCCH is a point-to-point unidirectional channel transmitting dedicated control information between a UE and a network and is used by a UE having an RRC connection.

A traffic channel is used to transmit user plane information. The DTCH is a point-to-point channel for transmitting user information, and exists in both of an uplink and a downlink. The MTCH is a point-to-multipoint downlink channel for transmitting traffic data, and is used for a UE that receives an MBMS.

The transport channel is classified according to how and with what characteristics data is transferred through a radio interface. Between different PHY layers, i.e., a PHY layer of a transmitter and a PHY layer of a receiver, data is transferred through a radio interface. The BCH is broadcast in the entire cell regions and has a fixed, predefined transmission format. The DL-SCH is featured in that it supports a hybrid automatic repeat request (HARM), supports modulation, coding, and dynamic link adaptation based on a change in transmit power, supports broadcast possibility, beamforming possibility, dynamic/semi-static resource allocation, supports discontinuous reception (DRX) for saving UE power, and supports MBMS transmission. The PCH is featured in that it supports DRX for saving UE power and is broadcast in the entire cell regions. The MCH is featured in that it is broadcast in the entire cell regions and supports an MBMS single frequency network (MBSFN). The MBSFN is a scheme of using a scrambling code and a spreading code which are common for broadcasting the same MBMS channel simultaneously in a plurality of cells forming an MBMS cell group.

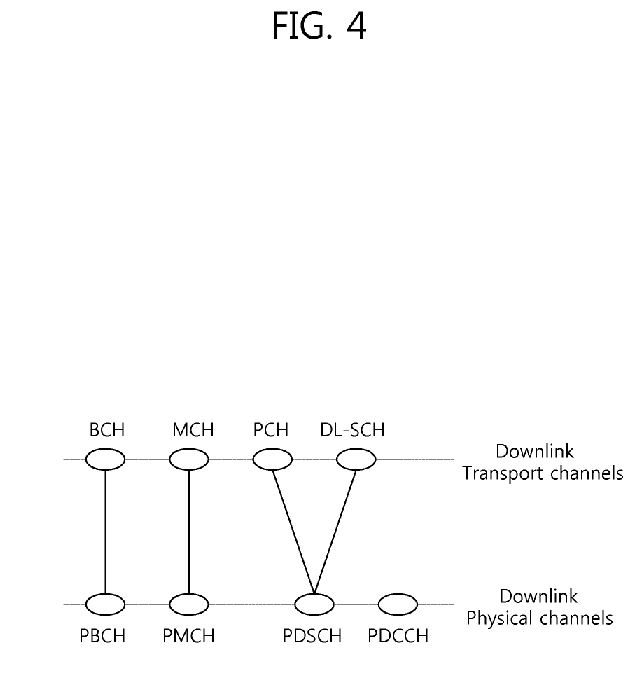

FIG. 4 is a view illustrating mapping between downlink transport channels and downlink physical channels.

Referring to FIG. 4, a BCH is mapped to a physical broadcast channel (PBCH), an MCH is mapped to a physical multicast channel (PMCH), and a PCH and DL-SCH are mapped to a PDSCH. The PBCH carries a BCH transmission block, the PMCH carries the MCH, and the PDSCH carries the DL-SCH and the PCH.

An MBMS uses two logical channels, i.e., an MCCH as a control channel and an MTCH as a traffic channel. User data such as actual voice or video is transmitted on the MTCH, and configuration information, or the like, for receiving the MTCH is transmitted on the MCCH. The MTCH and the MCCH are point-to-multipoint downlink channels for a plurality of UEs, which may be common channels. In the MBMS, rather than allocating radio resources corresponding to the number of UEs that are to receive the service, only radio resource with respect to a common channel is allocated, and the common channel is simultaneously received by a plurality of UEs, thus enhancing efficiency of radio resource.

In a case in which a UE, while receiving the MBMS, changes a cell due to a location movement, the UE may not continuously receive the MBMS. If the UE performs a decoding operation to continuously receive the MBMS even in this state, a battery thereof may be consumed. Thus, an apparatus and method for continuously receiving an MBMS without a waste of resource when a UE, which uses the MBMS, performs handover are required.

A source cell refers to a cell in which a UE is currently being provided with a service. A BS which provides the source cell is called a source BS. A neighbor cell refers to a cell adjacent to the source cell geographically or in a frequency band. A neighbor cell which uses the same band or frequency on the basis of a source cell is called an infra-frequency neighbor cell. Also, a neighbor cell which uses a different band or frequency on the basis of a is source cell is called an inter-frequency neighbor cell. Namely, neighbor cells of a source cell, i.e., a cell using a band or frequency different from that of the source cell, as well as a cell using a band or frequency the same as that of the source cell, may be called neighbor cells.

Performing handover by a UE from a source cell to an intra-frequency neighbor cell is called intra-frequency handover. Meanwhile, performing handover by a UE from a source cell to an inter-frequency neighbor cell is called inter-frequency handover. A neighbor cell to which a UE moves through handover is called a target cell, and a BS providing a target cell is called a target BS.

A source cell and a target cell may be provided by a single BS or may be provided by different BSs. Hereinafter, for the description purposes, it is assumed that a source cell and a target cell are provided by different BSs, i.e., a source BS and a target BS. Thus, a source BS and a source cell, and a target BS and a target cell may be mixedly used.

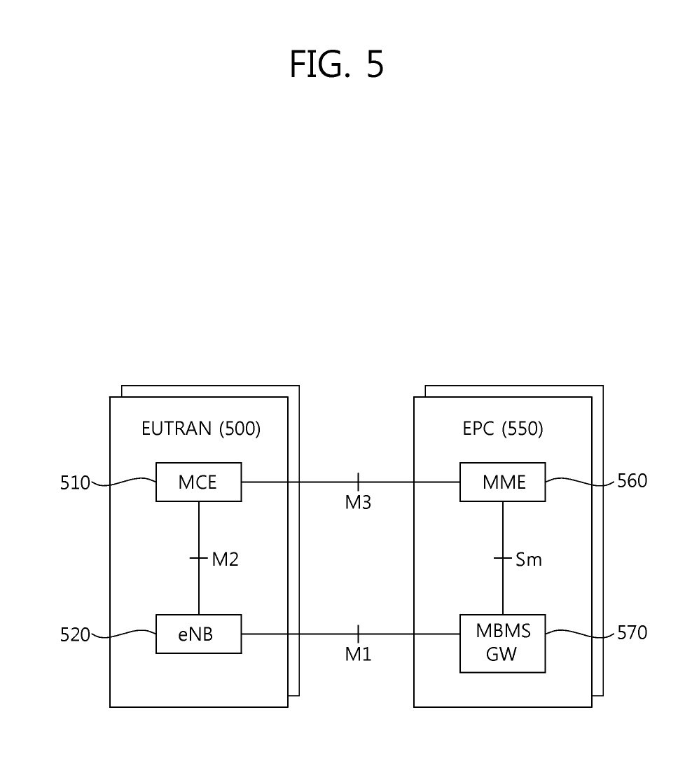

FIG. 5 is a view illustrating a structure of a core network for an MBMS to which the present invention is applied.

Referring to FIG. 5, a wireless access network (EUTRAN) 500 includes a multi-cell coordination entity (MCE) 510 and a BS (eNB) 520. The MCE 510, main entity which controls an MBMS, serves to allocate radio resource or control admission. The MCE 510 may be implemented within the eNB 520 or may be implemented as being independent from the eNB 520. An interface between the MCE 510 and the eNB 520 is called an M2 interface. The M2 interface is an internal control plane interface of the EUTRAN 500, through which MBMS control information is transmitted. When the MCE 510 is implemented within the eNB 520, the M2 interface may exist only logically.

An evolved packet core (EPC) 550 includes an MME 560 and an MBMS is gateway (GW) 570. The MME 560 performs operation such as NAS signaling, roaming, authentication, selection of a PDN GW and an S-GW, selection of MME for handover according to a change in MME, reachability with respect to an idle mode UE, AS security control, and the like.

The MBMS GW 570, an entity for transmitting MBMS service data, is positioned between the eNB 520 and a BM-SC and performs MBMS packet transmission and broadcast to the eNB 520. In order to transmit user data to the eNB 520, the MBMS GW 570 uses a PDCP and IP multicast, and performs session control signaling on the EUTRAN 500.

An interface between the MME 560 and the MCE 510 is a control plane interface between the EUTRAN 500 and the EPC 550, which is called an M3 interface. Through the M3 interface, control information regarding MBMS session control is transmitted.

An interface between the eNB 520 and the MBMS GW 570 is a user plane interface, which is called an M1 interface. Through the M1 interface, MBMS service data is transmitted.

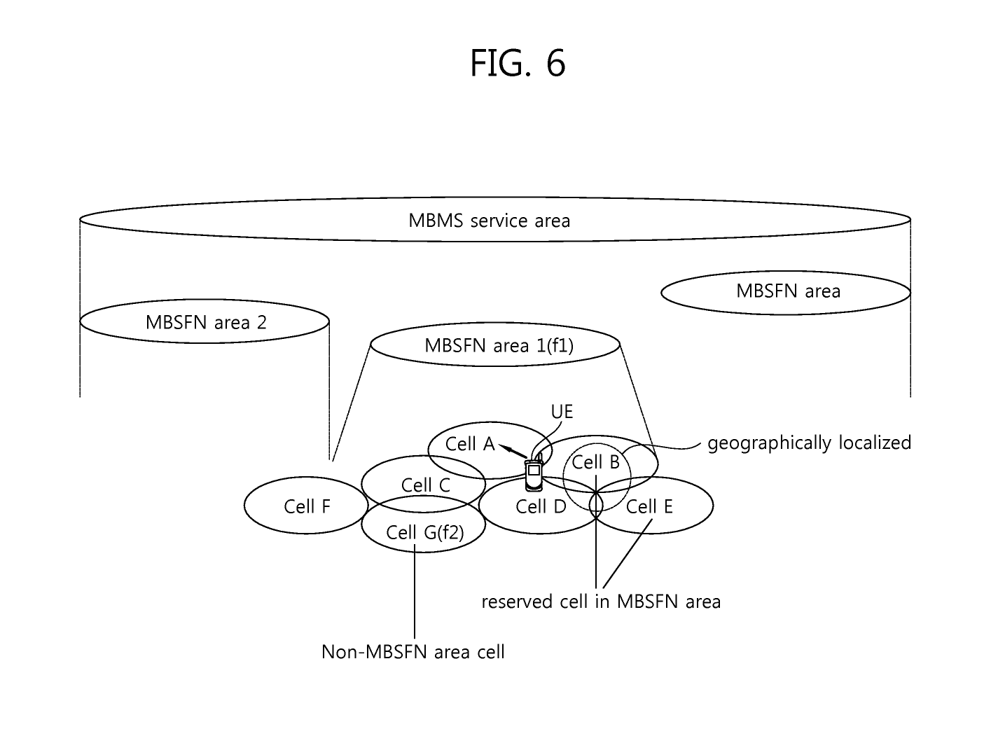

FIG. 6 is a view illustrating an example of a general scenario to which a handover method for continuity of a service in an MBMS according to an embodiment of the present invention.

Referring to FIG. 6, an MBMS may be managed on the basis of a cell or a location. An MBMS service area is a term representing an area in which a particular MBMS service is provided. For example, when an area in which a particular MBMS service A is provided is called an MBMS service area A, a network may be in a state of transmitting an MBMS service A in the MBMS service area A. In this case, a UE may receive the MBMS service A or not according to capabilities thereof. An MBMS service area may be defined in is terms of an application and a service as to whether a particular service is being provided or not in a certain area.

A cell A, a cell B, a cell C, a cell D, and a cell E are included in an MBSFN area 1, and a cell F is included in an MBSFN area 2. A cell G is a cell served by a different frequency band f2, not a cell of the MBSFN area. The MBSFN area refers to an area in which a particular MBMS service is provided in a single frequency band. For example, in case of an MBSFN area 1, a particular MBMS service A is supported in an MBSFN subframe. Also, in case of an MBSFN area 2, an MBMS service A is supported but by using a frequency resource f3 different from the frequency resource f1 in the MBSFN area 1. Within the same MBSFN area, although a UE moves, it may receive an MBMS service on the basis of the same MBMS configuration.

Meanwhile, the cell B and the cell E are reserved cells which are included in the MBSFN area 1 but do not transmit an MBMS service in a particular situation. The reserved cells may be defined as cells which do not currently provide the MBMS service through an MRB. In this case, the reserved cells may be cells which currently never support an MBMS service or may be cells which support an MBMS service through a dedicated bearer, rather than supporting the MBMS service through an MRB. Also, the reserved cells may limitedly support an MBMS service such that a particular MBMS service is provided only in a particular area. In other words, as an example of a location-based service, or the like, a particular MBMS service may be supported only in a particular area but not supported in any other area. Even in this case, an area or a cell in which a particular MBMS service is supported may be changed. Also, in this case, management of a reserved cell may be used as a method for managing an MBMS service area itself, as well as in the aspect of radio efficiency.

A reserved cell is included in the MBSFN area together with other cells providing an MBMS service. In a general case, cells within the MBSFN are configured to use the same MBSFN subframe for an MBMS, and may be considered to transmit an MBMS service to all the cells within the MBSFN area. However, in a case in which a service is supported through an MRB only in a localized position smaller than an area defined as the MBSFN area, or in a special case in which only a small amount of UEs are expected to receive an MBMS service in a particular area, or the like, it is effective to support an MBMS service through a dedicated bearer, rather than an MRB. Thus, in the case of the cell B and the cell E, although they are cells within the same MBSFN area as that of the cell A, the cell C, and the cell D, MBMS service may not be performed through an MRB.

A reserved cell may be determined on the basis of an MBMS location range. An MBMS location range is a concept used to manage an MBMS service such that the MBMS service is received through an MRB only within a particular area or a location range even in the same MBSFN area, in comparison to the existing case in which all the cells within the MBSFN area receive a service through an MRB. In this case, the MBMS location range may be managed by cell or may be managed geographically or through a geography-based localization, e.g., through positioning.

How MBMS service continuity is provided to a UE when the UE moves from a current cell D to a different cell will be described.

First, a case in which the UE moves between cells within the same MBSFN area will be described. For example, it is assumed that the UE moves to the cell A. Since the cell A is within the MBSFN area 1 the same as that of the cell D, although the UE moves to the cell A, the UE may continuously receive an MBMS service by using the same MBSFN subframe. Thus, there is no particular problem for the UE to receive the MBMS service in the cell A.

In another example, it is assumed that the UE moves to the cell G. The cell G is a cell within the MBSFN area 1 the same as that of the cell D, but it does not support the MBMS service and provides a service through the frequency f2. Thus, after the UE moves to the cell G, it cannot continuously receive the MBMS service.

In another example, it is assumed that the UE moves to the cell B as a reserved cell. For example, a distribution of UEs that use the MBMS service is concentrated on a different area, so a very small amount of UEs may receive the MBMS service by using an MRB in the cell B. In this case, supporting the service by the cell B through an MRB may not be desirable in terms of radio frequency. Thus, the cell B may support the MBMS service through a dedicated bearer only for a particular UE or a point-to-point bearer.

In this manner when the UE moves to the cell A, it may continuously receive the service through the existing MRB, but when the UE moves to the cell B, it may not be provide with the service through an MRB. In this case, the UE cannot know whether it can continuously receive the MBMS service through an MRB so the UE may attempt to receive the service through an MRB unnecessarily. Thus, in the case in which the UE is receiving the MBMS service through an MRB in a source BS, a target BS is required to provide information regarding whether an MBMS service is available to the source BS or the UE.

Next, a case in which the UE moves between MBSFN areas will be described. It is assumed that the UE moves from the MBSFN area 1 to the MBSFN area 2. The MBSFN area 2 to which the UE has moved may provide the same MBMS service in the same frequency band or may not. For example, it is assumed that the UE has moved to the cell F and the MBSFN area 1 provides the MBMS service through the frequency f1 in an MBSFN subframe and the MBSFN area 2 provides the MBMS service through a frequency f3 in the MBSFN subframe. In this case, the UE cannot automatically receive the MBMS service in the MBSFN area 2 through a scheme set in the MBSFN area 1 (i.e., through the frequency f1 in the MBSFN subframe).

If it is assumed that both the MBSFN area 1 and the MBSFN area 2 provide the MBMS service through the frequency f1 in the MBSFN subframe, although the MBSFN area is changed, it may be considered that the UE may be able to continuously receive the MBMS service in actuality because the MRB frequency for the MBMS service is the same.

In this manner, although the UE should be able to continuously receive the MBMS service through an MRB when it performs handover to a new target cell within a new MBSFN area, receiving the same MBMS service in the same frequency is not always guaranteed. This may occur due to a difference between the MBMS service provided in the new target cell and the MBMS service which was received by the UE, or may occur because the target cell does not transmit the corresponding MBMS service. In any event, in order to continuously provide the MBMS service to the UE during the handover process, the target BS is required to first obtain information regarding the MBMS service that the UE was received.

The target BS may obtain the information regarding the MBMS service after handover by the UE is completed or before handover by the UE is completed. For example, before handover is completed, the target BS may receive information regarding the MBMS service from the source BS. Also, the source BS or the target BS may directly request the information regarding the MBMS service from the UE to obtain it or may obtain the information regarding the MBMS service without a request. When the target BS obtains the information regarding the MBMS service, the target BS may reconfigure an MRB on the basis of a new is configuration according to capabilities of the UE or may provide the MBMS service through a dedicated bearer or a point-to-point bearer.

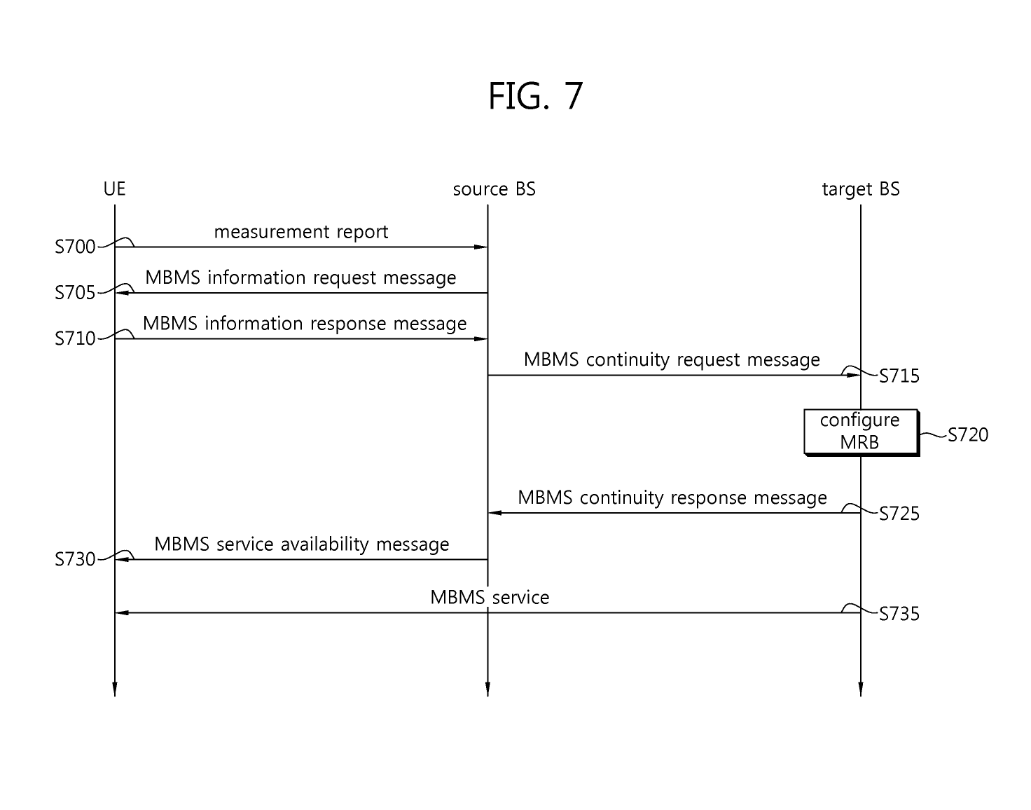

FIG. 7 is a flow chart illustrating a method for transmitting control information for continuity of an MBMS service according to an example of the present invention.

Referring to FIG. 7, the UE, which is receiving an MBMS, transmits a measurement report to the source BS (eNB) (S700). The measurement report includes information regarding strength (or power) or quality of a signal received by the UE from a neighbor cell, as well as a source cell. The source BS uses the measurement report as a barometer for determining necessity of handover.

When the source BS determines that handover is required, the source BS transmits an MBMS information request message requesting information regarding the MBMS service from the UE to the UE (S705). The information regarding the MBMS service includes at least one of information regarding whether the UE is currently receiving the MBMS service, information regarding a type of the MBMS service, and information regarding a cell or frequency in which the MBMS service is received.

The UE transmits an MBMS information response message to the source BS (S710). The MBMS information response message informs about whether the UE receives the MBMS service through an MRB and/or a type of the MBMS service.

For example, the MBMS information response message is an indicator indicating whether the UE receives the MBMS service through an MRB. For example, a form of the MBMS information response message may be a flag and it may indicate 0 or 1. When the MBMS information response message is 1, the UE is a terminal that receives an MBMS service, and when the MBMS information response message is 0, the UE is a terminal that does not is receive an MBMS service. Of course, the flag may indicate in a reverse manner. Here, although the UE receives only at least one MBMS service among a plurality of MBMS services, the MBMS information response message may be set to 1.

In another example, the MBMS information response message may be an indicator indicating a type of the MBMS service that the UE receives. This is because the UE may simultaneously receive a plurality of MBMS services, MBMS areas or MBSFN areas for respective MBMS services may be different, or which MBMS service is being provided in a location in which the UE is currently receiving the MBMS service is required to be informed. Types of MBMS services may be identified by temporary mobile group identity (TMGIs) with respect to MBMS services.

For example, when the UE is receiving MBMS services A, B, and C, the MBMS information response message may be configured in the form of a list such as TMGI A, B, C. Alternatively, a single MBMS information response message may indicate a single MBMS service type. Namely, an MBMS service type may be configured in an individual MBMS information response message and transmitted. For example, it may be configured such that an MBMS information response message 1=TMGI A, AN MBMS information response message 2=TMGI B, and an MBMS information response message 3=TMGI C.

In another example, the MBMS information response message may indicate a type of an MBMS service and whether an MBMS is received. Namely, the MBMS information response message may indicate whether an MBMS is received by a flag and simultaneously indicate a type of the MBMS service being received.

The source BS transmits an MBMS continuity request message to the target BS (S715). The MBMS continuity request message may be information requesting MBMS control by the source BS from the target BS in order to guarantee MBMS service continuity of the UE, and may have the same form as that of the MBMS information response message or may include the same information. For example, the MBMS continuity request message may include a flag indicating whether the UE receives an MBMS service. In this case, the target BS may recognize whether the UE is a terminal that receives an MBMS service, through the flag.

Alternatively, the MBMS continuity request message may indicate a type of the MBMS service that the UE receives. In this case, the target BS may recognize a type of the MBMS service that the UE receives. The MBMS continuity request message may be information defined in the X2 interface. The MBMS continuity request message may be included in a handover request message or may be a message independent from a handover request message.

The target BS may check whether the UE receives an MBMS from the MBMS continuity request message, determines whether it can support continuity of the MBMS service with respect to the UE, and configures an MRB (S720). When the UE is checked as a terminal that receives an MBMS service, the target BS determines whether it can support the MBMS service continuity with respect to the UE. Meanwhile, when the UE is a terminal that does not receive an MBMS service, the target BS determines not to support MBMS service continuity of the UE.

For example, the determining whether to support the MBMS service continuity may include determining whether an MBMS service itself can be provided or not.

In another example, in a case in which a target BS is changed, determining regarding supporting an MBMS service continuity includes determining through which cell, component carrier, or frequency, each MBMS service is to be provided. This is because, a particular MBMS service may be supported only through a particular cell, component carrier, or frequency. Carrier aggregation (CA) supports a plurality of carriers, which is also called spectrum aggregation or bandwidth aggregation. Individual unit carriers grouped by carrier aggregation is called component carriers (CC). In order to transmit and receive packet data through a particular cell, the UE should first complete configuration of a particular cell or a CC. Here, configuration refers to a state in which receiving of system information required for transmitting and receiving data with respect to a corresponding cell or CC is completed.

In case of handover in consideration of CA, both a primary serving cell (PCell) and a secondary serving cell (SCell) should be considered. For example, when a PCell is changed to an SCell within the same BS, it is intra-BS (or intra-eNB) handover, and when a PCell is changed to a particular cell of a different BS, it is inter-BS (or inter-eNB) handover.

In another example, determining regarding supporting MBMS service continuity includes determining a type of the MBMS service that the UE receives, and determining regarding which cell, CC, or frequency is to be transmitted according to each type of the MBMS service. This is because there may be an MBMS service that the target BS can support and there may be an MBMS service that the target BS cannot support, and also, each MBMS service may be supported only through a different cell, CC, or frequency.

In another example, determining regarding supporting MBMS service continuity may further include determining whether to provide an MBMS service through a dedicated bearer (or a point-to-point bearer) or through an MRB. When the amount of UEs that receive an MBMS service is more than a threshold value in the target cell, the target cell may configure an MRB, rather than a dedicated bearer, and provide an MBMS service by using an MBSFN subframe. For example, it is assumed that a particular threshold value is 10 (UEs). When the is amount of UEs is 10 due to movements of UEs, it is desirable for the target cell to provide the MBMS service by using an MRB, rather than through a dedicated bearer, in terms of radio efficiency. Thus, the target BS may configure an MRB for the MBMS service.

The target BS transmits an MBMS continuity response message to the source BS (S725). The MBMS continuity response message indicates whether the target BS can support the MBMS service through an MRB. Here, the MBMS service may include a service supported through a dedicated RB, as well as a service supported through an MRB. Also, the MBMS continuity response message may include MBMS session identifier information providing information regarding an MBMS session to the UE. The MBMS continuity response message may be included in a handover request acceptance message and transmitted, or may be included in an independent message and transmitted.

For example, the MBMS continuity response message may indicate only whether the MBMS service can be supported. For example, when it is determined that the UE uses an MBMS service according to the results of determining supporting of MBMS service continuity, the target BS sets the MBMS continuity response message to 1. This indicates that the MBMS service with respect to the UE may be continuously supported by the target BS. Namely, it means that the UE may receive the same MBMS service as that in the serving BS. Conversely, when it is determined that the UE does not use an MBMS service according to the results of determining supporting of MBMS service continuity, the target BS sets the MBMS continuity response message to 0. This means that the MBMS service with respect to the UE cannot be continuously supported in the target BS.

In another example, the MBMS continuity response message may include information regarding a cell, a CC, or a frequency to be used to provide the MBMS service to the UE.

In another example, the MBMS continuity response message may include information regarding a type of the MBMS service that the UE receives and information regarding a cell, a CC, or a frequency that can be supported by MBMS service in the target BS as shown in Table 1.

TABLE 1

| MBMS service type | TMGI | enable/disable | frequency |
|---|---|---|---|
| MBMS service 1 | A | enable | CC1 |
| MBMS service 2 | B | disable | CC2 |
| MBMS service 3 | C | enable | CC3 |

Referring to Table 1, the MBMS continuity response message includes information regarding a TMGI identifying each MBMS service, information regarding whether a corresponding MBMS service can be supported in the target BS (enable/disable) and information regarding supported frequency bands (CC1, CC2, CC3, etc.).

In another example, the MBMS continuity response message indicates whether the target BS supports an MBMS service through an MRB. Table 2 shows an example of the MBMS continuity response message.

TABLE 2

| MBMS service type | TMGI | MRB on/off |
|---|---|---|
| MBMS service 1 | A | off |
| MBMS service 2 | B | on |
| MBMS service 3 | C | off |

Also, when the target BS provides a closed subscriber group (CGS) cell in relation to a femto BS (or a femto eNB), the MBMS continuity response message may indicate whether a CSG cell supports an MBMS service. When the target BS provides a CSG cell, the MBMS continuity response message may be transmitted from the target BS corresponding to the CSG cell to an MME and from the MME to the source BS.

The source BS transmits an MBMS service availability message indicating that the MBMS service is available in the target BS to the UE (S730). The MBMS service availability message may include a function and contents which are the same as those of the MBMS continuity response message. Also, the MBMS service availability message may be included in a handover command message or may be an independent message. The UE may obtain information regarding whether the MBMS service can be supported in the target BS and information regarding a cell, a CC, or a frequency in which the MBMS service is provided, by using the information included in the MBMS service availability message.

The target BS transmits the MBMS service to the UE (S735). The UE may receive the MBMS service that can be supported in a particular cell or a frequency within the target BS according to each MBMS service type. Accordingly, the UE may receive the MBMS service ceaselessly even after it moves to the target BS. Namely, continuity of the MBMS service is guaranteed for the UE.

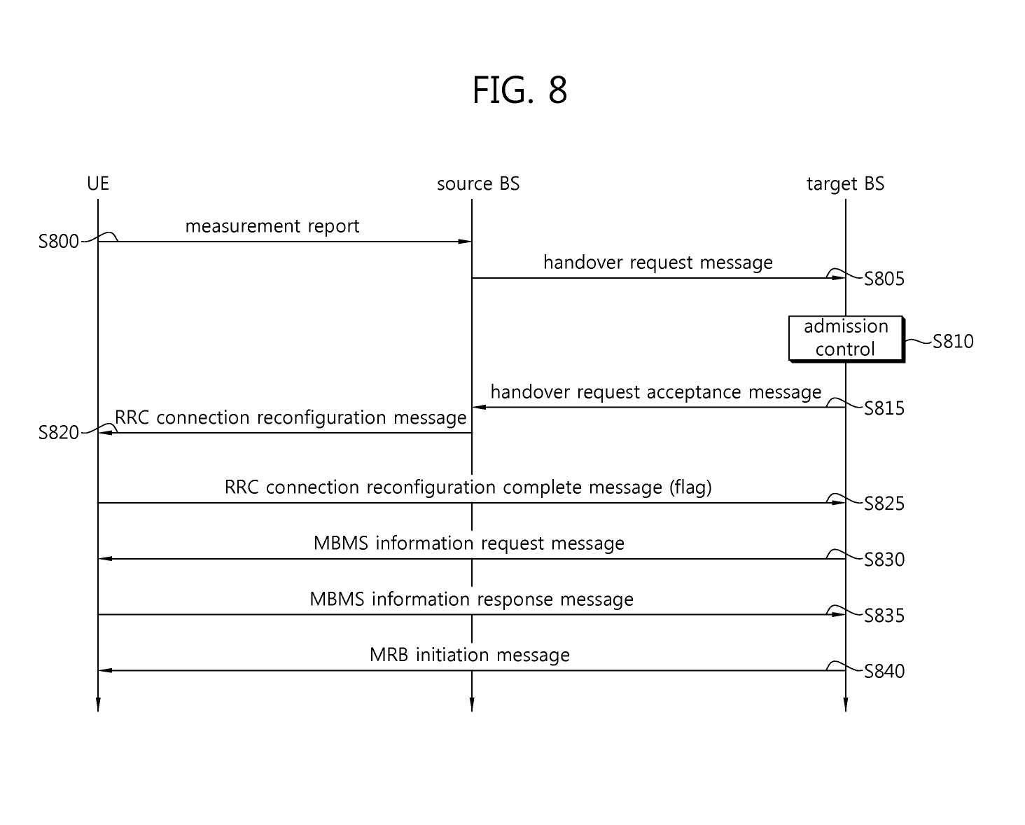

FIG. 8 is a flow chart illustrating a method for transmitting control information for continuity of an MBMS service according to another example of the present invention.

Referring to FIG. 8, the UE transmits a measurement report to the source BS (S800). The measurement report includes information regarding strength (or power) of quality of a signal received by the UE from a neighbor cell, as well as those of the source cell. The source BS uses the measurement report as a barometer for determining the necessity of handover.

When the source BS determines that handover is required for the UE, the source BS transmits a handover request message to the target BS (S805), and the target BS performs admission control (S810) and transmits a handover request acceptance message to the source BS (S815).

The source BS transmits an RRC connection reconfiguration message to the UE (S820). The UE reconfigures an RRC connection on the basis of the RRC connection reconfiguration message, and when the reconfiguration of the RRC connection is completed, the UE transmits an RRC connection reconfiguration complete message to the target BS (S825). If the UE was receiving an MBMS service, since the UE is to receive the MBMS service ceaselessly, the UE should inform the target BS that it is a terminal receiving the MBMS service even after performing handover. Namely, the UE should take measures to continuously receive the MBMS service. This may be manifest by the RRC connection reconfiguration complete message. For example, the RRC connection reconfiguration complete message includes a flag to indicating whether the UE receives an MBMS service. When the flag is 1, the UE is a terminal that receives an MBMS service, and when the flag is 0, the UE is a terminal which does not receive an MBMS service. Of course, the flag may indicate in a reverse manner. Table 3 shows an example of the RRC connection reconfiguration complete message according to an embodiment of the present invention.

TABLE 3
RRCConnectionReconfigurationComplete ::= SEQUENCE {
rrc-TransactionIdentifierRRC-TransactionIdentifier,
criticalExtensionsCHOICE {
rrcConnectionReconfigurationComplete-r8
RRCConnectionReconfigurationComplete-r8-IEs,
criticalExtensionsFutureSEQUENCE { }
}
}
RRCConnectionReconfigurationComplete-r8-IEs ::= SEQUENCE {
nonCriticalExtensionRRCConnectionReconfigurationComplete-v8a0-IEs
OPTIONAL
}
RRCConnectionReconfigurationComplete-v8a0-IEs ::= SEQUENCE {
lateNonCriticalExtensionOCTET STRINGOPTIONAL,

| | |
|---|---|
| nonCriticalExtensionRRCConnectionReconfigurationComplete-v10xy-IEs | OPTIONAL |

}
RRCConnectionReconfigurationComplete-v10xy-IEs ::= SEQUENCE {
rlf-InfoAvailable-r10ENUMERATED {true}OPTIONAL,
logMeasAvailable-r10ENUMERATED {true}OPTIONAL,
nonCriticalExtensionSEQUENCE { }OPTIONAL
}
RRCConnectionReconfigurationComplete-v11xy-IEs ::= SEQUENCE {
activeServiceMBMSENUMERATED {true}OPTIONAL,
nonCriticalExtensionSEQUENCE { }OPTIONAL
}

Referring to FIG. 3, the RRC connection reconfiguration complete message (RRCConnectionReconfigurationComplete-v11xy-IEs) includes an activeServiceMBMS field, and it may be a flag indicating whether the UE receives an MBMS service and may be a field used in an LTE release 11 system. Also, the activeServiceMBMS field may be information regarding an MBMS service(s) that the UE received in the source BS.

The target BS transmits an MBMS information request message for requesting information regarding the MBMS service from the UE to the UE (S830). The information regarding an MBMS service may include at least one of information regarding whether the UE is currently receiving an MBMS service, information regarding a type of the MBMS service, and information regarding a cell or frequency in which the MBMS service is received. Or, if the UE is a terminal available for carrier aggregation (CA), the information regarding the MBMS service may include information regarding a primary serving cell PCell or a secondary serving cell SCell in which the MBMS service is received. When the UE receives the information regarding the PCell or the SCell in which the MBMS service is received, the UE may receive the MBMS service from the corresponding cell.

For example, after the UE receives the information regarding the SCell for receiving the MBMS service, if the corresponding SCell has not been activated, the corresponding cell is activated. In other words, in the case in which the MBMS information request message includes information regarding the SCell which is not currently activated or configured, the UE may activate the corresponding SCell upon receiving it, and use the SCell to receive the MBMS service.

The UE transmits an MBMS information response message to the target BS (S835). The MBMS information response message informs about whether the UE receives the MBMS service through an MRB and/or active MBMS service information regarding a type of the MBMS service. For example, when the UE is receiving MBMS services A, B, and C, the MBMS information response message may be configured in the form of a list such as TMGI A, B, and C. Alternatively, a single MBMS information response message may indicate a single MBMS service type. Namely, the MBMS service type may be configured in an individual MBMS information response message and transmitted. For example, it may be configured such that an MBMS information response message 1=TMGI A, an MBMS information response message 2=TMGI B, and an MBMS information response message 3=TMGI C. Alternatively, in case of a UE available for CA, information indicating that the corresponding SCell is activated to receive the MBMS service may be provided.

The target BS transmits an MRB initiation message to the UE (S840). The MRB initiation message informs the UE that the target BS supports the MBMS service through an MRB. Since the target BS may not support a particular type of MBMS service by an MRB, the target BS may inform the UE about a type of MBMS service that can be supported by an MRB and a type of MBMS service that cannot be supported by an MRB through the MRB initiation message. In this case, the UE may determine whether the MBMS service is supported through an MRB, and determine whether to receive the MBMS service on the basis of the determination.

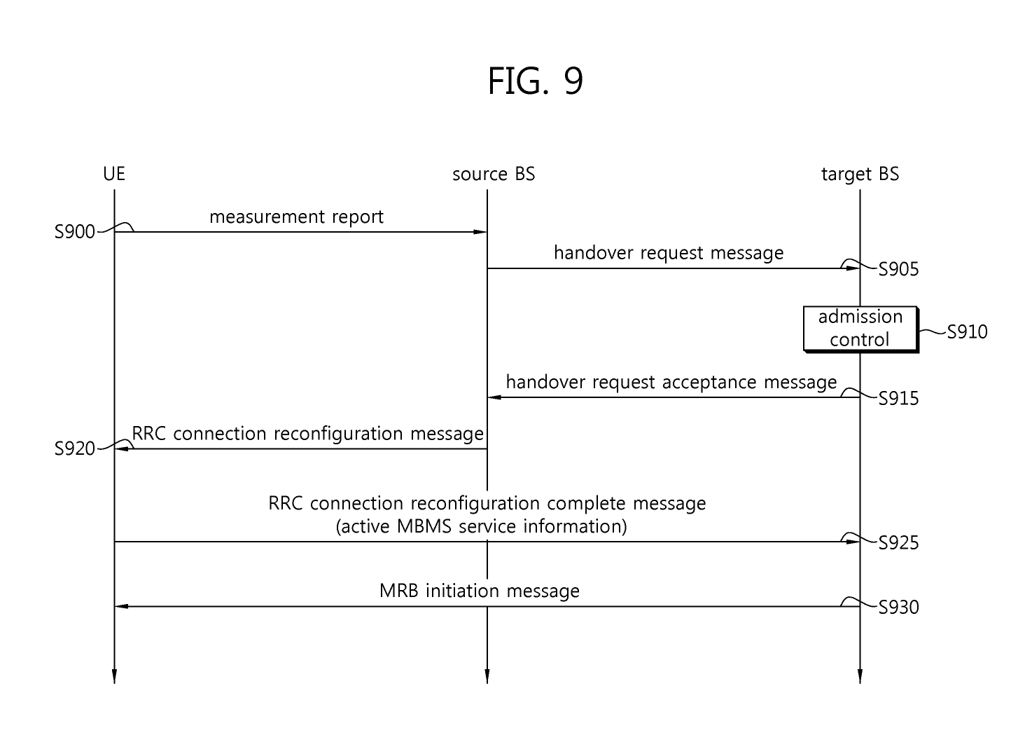

FIG. 9 is a flow chart illustrating a method for transmitting control information for continuity of an MBMS service according to another example of the present invention.

Referring to FIG. 9, the UE transmits a measurement report to the source BS (S900). The measurement report includes information regarding strength (or power) or quality of a signal received by the UE from a neighbor cell, as well as a source cell. The source BS uses the measurement report as a barometer for determining necessity of handover.

When the source BS determines that handover is required for the UE, the source BS transmits a handover request message to the target BS (S905), and the target BS performs admission control (S910) and transmits a handover request acceptance message to the source BS (S915).

The source BS transmits an RRC connection reconfiguration message to the UE (S920). The UE reconfigures an RRC connection on the basis of the RRC connection reconfiguration message, and when the RRC reconfiguration is completed, the source BS transmits an RRC connection reconfiguration complete message to the target BS (S925). If the UE was receiving an MBMS service, since the UE is to receive the MBMS service ceaselessly, the UE should inform the target BS that it is a terminal receiving the MBMS service even after performing handover. To this end, the UE may include active MBMS service information in the RRC connection reconfiguration complete message and transmit the same. Table 4 shows an example of the active MBMS service information.

TABLE 4

| MBMS service type | TMGI | enable/disable | Frequency |
|---|---|---|---|
| MBMS service 1 | A | enable | CC1 |
| MBMS service 2 | B | disable | CC2 |
| MBMS service 3 | C | enable | CC3 |

Referring to Table 4, the active MBMS service information includes a TMGI identifying each MBMS service, whether a corresponding MBMS service is supported in a target BS (enable/disable), and information regarding supported frequency bands CC1, CC2, CC3, and the like). When the active MBMS service information is received, the target BS may recognize details of the MBMS that the UE has received. For example, when the UE informs the target BS about only a flag, the target BS may be required to perform a procedure for transmitting an MBMS information request message or receiving an MBMS information response message (please refer to steps S830 and S835) to recognize details. However, when the active MBMS service information is included in the RRC connection reconfiguration complete message as in step S925, exchanging of the MBMS information request and response messages may not be required.

Thus, the target BS transmits an MRB initiation message to the UE (S930). The MRB initiation message informs the UE that the target BS supports the MBMS service through an MRB. Since the target BS may not support a particular type of MBMS service by an MRB, the target BS may inform the UE about a type of MBMS service that can be supported by an MRB and a type of MBMS service that cannot be supported by an MRB through the MRB initiation message. In this case, the UE may determine whether the MBMS service is supported through an MRB, and determine whether to receive the MBMS service on the basis of the is determination.

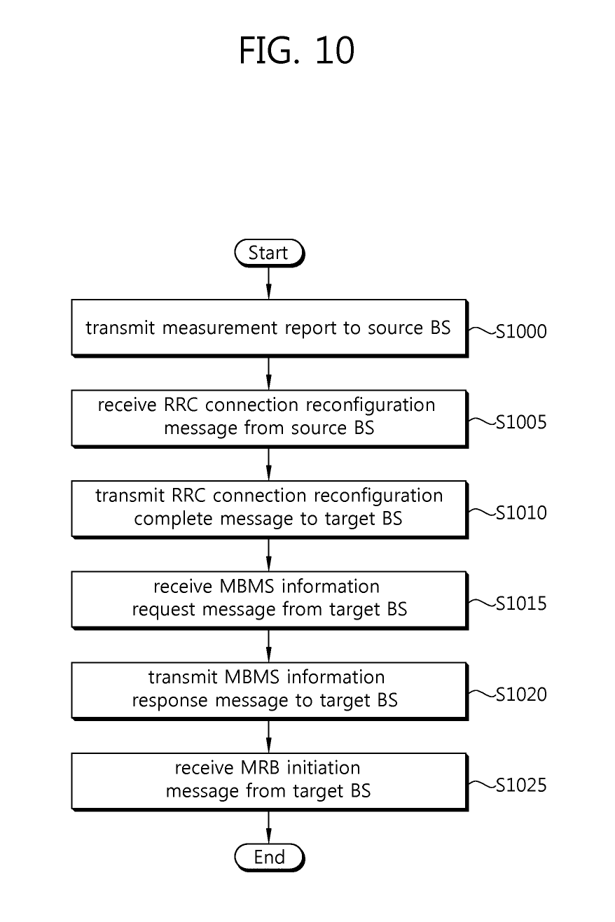

FIG. 10 is a flow chart illustrating an operation of a UE that receives an MBMS service according to an example of the present invention.

Referring to FIG. 10, the UE transmits a measurement report to the source BS (S 1000). The measurement report includes information regarding strength (or power) or quality of a signal received by the UE from a neighbor cell, as well as a source cell. The source BS uses the measurement report as a barometer for determining necessity of handover.

The UE receives an RRC connection reconfiguration message from the source BS (S1005). The UE reconfigures an RRC connection on the basis of the RRC connection reconfiguration message, and when the reconfiguration of the RRC connection is completed, the UE transmits an RRC connection reconfiguration complete message to the target BS (S1010). If the UE was receiving an MBMS service, since the UE is to receive the MBMS service ceaselessly, the UE should inform the source BS that it is a terminal receiving the MBMS service even after performing handover. Namely, the UE should take measures to continuously receive the MBMS service. This may be manifest by the RRC connection reconfiguration complete message.

For example, the RRC connection reconfiguration complete message includes a flag indicating whether the UE receives an MBMS service. When the flag is 1, the UE is a terminal that receives an MBMS service, and when the flag is 0, the UE is a terminal which does not receive an MBMS service.

In another example, the UE may include active MBMS service information in the RRC connection reconfiguration complete message and transmit the same. In this case, steps S1015 and S1020 may be omitted.

The UE receives an MBMS information request message for requesting information regarding an MBMS service from the target BS (S 1015). The information regarding an MBMS service may include at least one of whether the UE is currently receiving an MBMS service, a type of the MBMS service, and information regarding a cell or frequency in which the MBMS service is received.

The UE transmits an MBMS information response message to the target BS (S1020). The MBMS information response message informs about whether the UE receives the MBMS service through an MRB and/or active MBMS service information regarding a type of the MBMS service. For example, when a plurality of MBMS UEs are receiving MBMS services A, B, and C, the MBMS information response message may be configured in the form of a list such as TMGI A, B, and C. Alternatively, a single MBMS information response message may indicate a single MBMS service type. Namely, the MBMS service type may be configured individually in the MBMS information response message and transmitted. For example, it may be configured such that an MBMS information response message 1=TMGI A, an MBMS information response message 2=TMGI B, and an MBMS information response message 3=TMGI C.

The UE receives an MRB initiation message from the target BS (S1025). The MRB initiation message informs the UE that the target BS supports the MBMS service through an MRB. Since the target BS may not support a particular type of MBMS service by an MRB, the target BS may inform the UE about a type of MBMS service that can be supported by an MRB and a type of MBMS service that cannot be supported by an MRB through the MRB initiation message. In this case, the UE may determine whether the MBMS service is supported through an MRB, and determine whether to receive the MBMS service on the basis of the is determination.

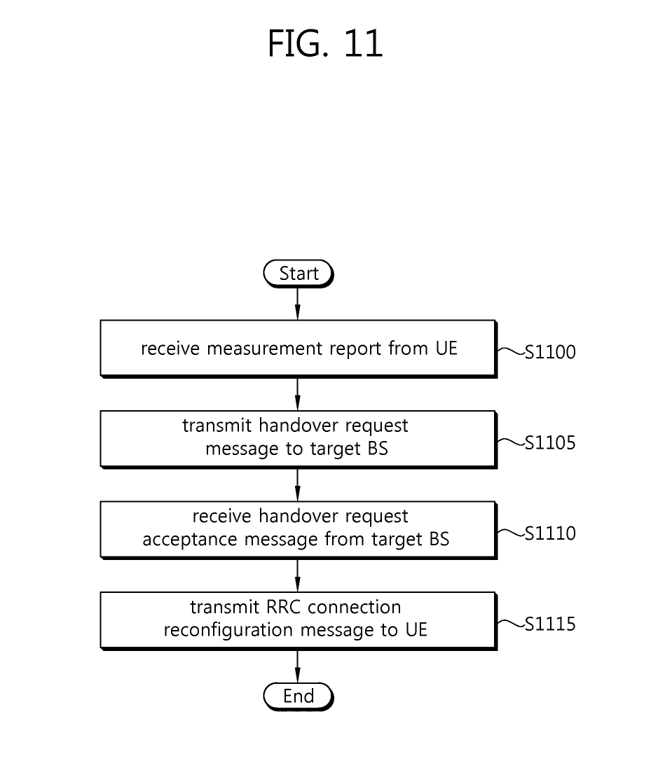

FIG. 11 is a flow chart illustrating an operation of the source BS that receives an MBMS service according to an example of the present invention.

Referring to FIG. 11, the source BS receives a measurement report from the UE (S1100). The measurement report includes information regarding strength (or power) or quality of a signal received by the UE from a neighbor cell, as well as a source cell. The source BS uses the measurement report as a barometer for determining necessity of handover.

If a subject requesting the information regarding an MBMS service of the UE is the source BS, the UE may receive a MBMS information request message from the source BS and transmit an MBMS information response message to the source BS, before handover is completed. And, the source BS delivers the information regarding the MBMS service to the target BS. Meanwhile, when a subject requesting information regarding an MBMS service of the UE is the target BS, the UE may receive an MBMS information request message from the target BS and transmit an MBMS information response message to the target BS, after handover is completed.

When the source BS determines that handover is required for the UE, the source BS transmits a handover request message to the target BS (S1105) and receives a handover request acceptance message indicating that handover is accepted, from the target BS (S1110). The source BS transmits an RRC connection reconfiguration message to the UE (S1115).

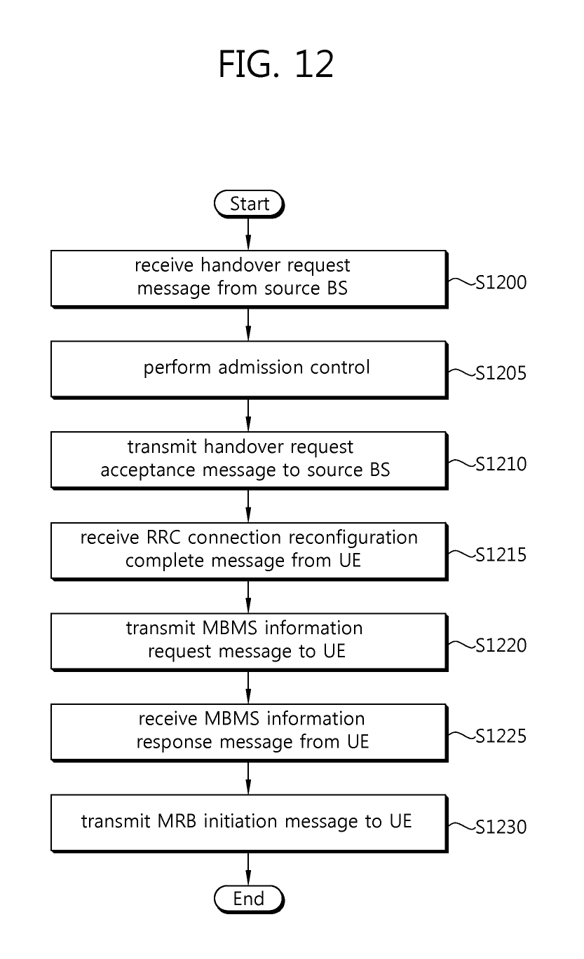

FIG. 12 is a flow chart illustrating an operation of a target BS that receives an MBMS service according to an example of the present invention.

Referring to FIG. 12, when handover is required for the UE, the target BS receives a handover request message from the source BS (S1200) and performs admission is control (S1205). The target BS transmits a handover request acceptance message indicating that handover is accepted, to the source BS (S1210).

When the reconfiguration of the RRC connection is completed, the target BS receives an RRC connection reconfiguration complete message from the UE (S1215). If the UE was receiving an MBMS service, since the UE is to receive the MBMS service ceaselessly, the UE should inform the source BS that it is a terminal receiving the MBMS service even after performing handover. Namely, the UE should take measures to continuously receive the MBMS service. This may be manifest by the RRC connection reconfiguration complete message.

For example, the RRC connection reconfiguration complete message includes a flag indicating whether the UE receives an MBMS service. When the flag is 1, the UE is a terminal that receives an MBMS service, and when the flag is 0, the UE is a terminal which does not receive an MBMS service.

In another example, the UE may include active MBMS service information in the RRC connection reconfiguration complete message and transmit the same. In this case, steps S1220 and S1225 may be omitted.

The target BS transmits an MBMS information request message for requesting information regarding an MBMS service from the UE to the UE (S1220). The information regarding an MBMS service may include at least one of whether the UE is currently receiving an MBMS service, a type of the MBMS service, and information regarding a cell or frequency in which the MBMS service is received.

The target BS receives an MBMS information response message from the UE (S1225). The MBMS information response message informs about whether the UE receives the MBMS service through an MRB and/or active MBMS service information regarding a type of the MBMS service. For example, when a plurality of MBMS UEs are receiving MBMS services A, B, and C, the MBMS information response message may be configured in the form of a list such as TMGI A, B, and C. Alternatively, a single MBMS information response message may indicate a single MBMS service type. Namely, the MBMS service type may be configured individually in the MBMS information response message and transmitted. For example, it may be configured such that an MBMS information response message 1=TMGI A, an MBMS information response message 2=TMGI B, and an MBMS information response message 3=TMGI C.

The target BS transmits an MRB initiation message to the UE (S1230). The MRB initiation message informs the UE that the target BS supports the MBMS service through an MRB. Since the target BS may not support a particular type of MBMS service by an MRB, the target BS may inform the UE about a type of MBMS service that can be supported by an MRB and a type of MBMS service that cannot be supported by an MRB through the MRB initiation message. In this case, the UE may determine whether the MBMS service is supported through an MRB, and determine whether to receive the MBMS service on the basis of the determination.

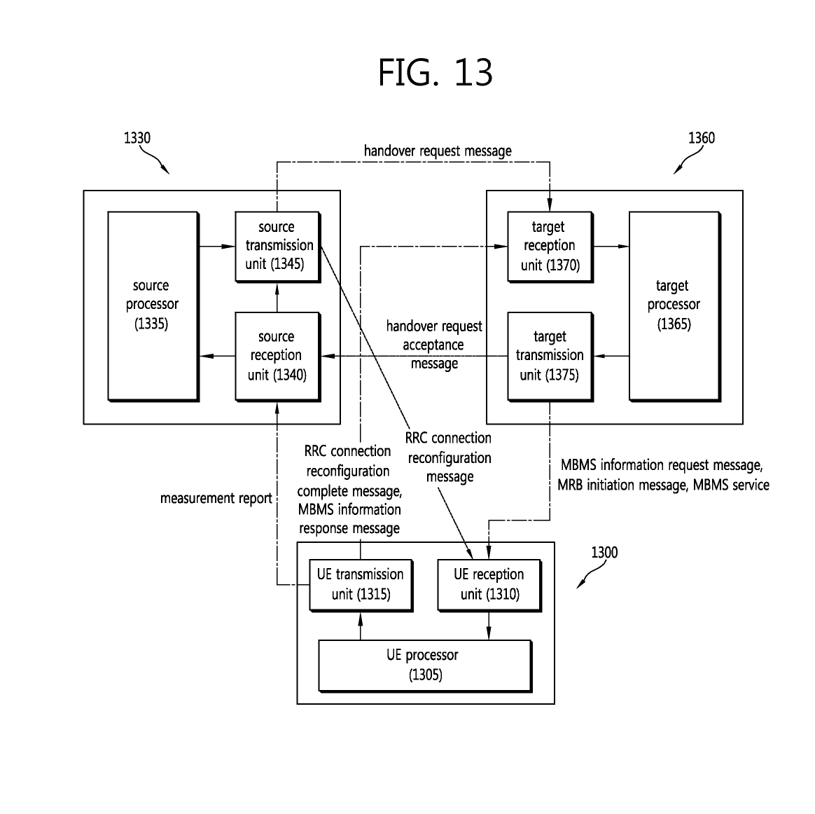

FIG. 13 is a block diagram illustrating a UE, a source BS and a target BS according to an embodiment of the present invention.

Referring to FIG. 13, a UE 1300 includes a UE processor 1305, a UE reception unit 1310, and a UE transmission unit 1315. The UE processor 1305 measures a signal received from a target cell as a neighbor cell of a source cell and generates a measurement report. The measurement report includes strength or quality of the signal received by the UE 1300 from the neighbor cell as well as that of the source cell. The measurement report is used as a barometer is for determining the necessity of handover.

The UE processor 1305 reconfigures an RRC connection on the basis of an RRC connection reconfiguration message received from the source BS 1330, and when the RRC connection reconfiguration is completed, the UE processor 1305 generates an RRC connection reconfiguration complete message. If the UE was receiving an MBMS service, since the UE is to receive the MBMS service ceaselessly, the UE should inform the source BS that it is a terminal receiving the MBMS service even after performing handover. Namely, the UE should take measures to continuously receive the MBMS service. This may be manifest by the RRC connection reconfiguration complete message.

For example, the UE processor 1305 may insert a flag indicating whether the UE 1300 receives an MBMS service into the RRC connection reconfiguration complete message. When the flag is 1, the UE is a terminal that receives an MBMS service, and when the flag is 0, the UE is a terminal which does not receive an MBMS service.

In another example, the UE processor 1305 may insert active MBMS service information into the RRC connection reconfiguration complete message. When the UE 1300 is receiving MBMS services A, B, and C, the active MBMS service information may be configured in the form of a list such as TMGI A, B, and C.

The UE processor 1305 generates an MBMS information response message. The MBMS information response message informs about whether the UE 1300 receives the MBMS service through an MRB (e.g., a flag) and/or active MBMS service information regarding a type of the MBMS service. For example, when the UE 1300 is receiving MBMS services A, B, and C, the MBMS information response message may be configured in the form of a list such as TMGI A, B, and C. Alternatively, a single MBMS information response message may indicate is a single MBMS service type. Namely, the MBMS service type may be configured individually in the MBMS information response message and transmitted. For example, it may be configured such that an MBMS information response message 1=TMGI A, an MBMS information response message 2=TMGI B, and an MBMS information response message 3=TMGI C.

The UE reception unit 1310 receives an MRB initiation message from the target BS 1360. The UE processor 1305 may determine whether the MBMS service is supported through an MRB on the basis of the MRB initiation message, and may determines whether to receive the MBMS service on the basis of the determination. Also, the UE reception unit 1310 receives an RRC connection reconfiguration message from the source BS 1330 and receives an MBMS information request message from the target BS 1360.

The UE transmission unit 1315 transmits a measurement report to the source BS 1330 and transmits an RRC connection reconfiguration complete message and an MBMS information response message to the target BS 1360.

The source BS 1330 includes a source processor 1335, a source reception unit 1340, and a source transmission unit 1345.

The source processor 1335 determines whether handover is required for the UE 1300 on the basis of the measurement report received from the UE 1300. When the source processor 1335 determines that handover is required, the source processor 1335 generates a handover request message and generates an RRC connection reconfiguration message for reconfiguring an RRC connection.

The source reception unit 1340 receives the measurement report from the UE 1300 and receives a handover request acceptance message indicating that handover is accepted, is from the target BS 1360.

The source transmission unit 1345 transmits the RRC connection reconfiguration message to the UE 1300, and transmits the handover request message to the target BS 1360.

The target BS 1360 includes a target processor 1365, a target reception unit 1370, and a target transmission unit 1375.

The target processor 1365 performs admission control with respect to the handover request from the source BS 1330. The target processor 1365 generates a handover request acceptance message indicating that handover is accepted, generates an MBMS information request message, and generates an MRB initiation message. In this case, the handover request acceptance message may include an MBMS continuity response message. The MBMS information request message is a message for requesting information regarding an MBMS service. The information regarding an MBMS service includes at least one of information regarding whether the UE is currently receiving the MBMS service, information regarding a type of the MBMS service, and information regarding a cell or frequency in which the MBMS service is received.

The MRB initiation message informs the UE 1300 that the target BS 1360 supports the MBMS service through an MRB. Since the target BS 1360 may not support a particular type of MBMS service by an MRB, the target BS 1360 may inform the UE 1300 about a type of MBMS service that can be supported by an MRB and a type of MBMS service that cannot be supported by an MRB through the MRB initiation message.

The target reception unit 1370 receives the handover request message from the source BS 1330 and receives the RRC connection reconfiguration complete message or the MBMS information response message from the UE 1300.

The target transmission unit 1375 transmits a handover request acceptance message to the source BS 1330. Also, the target transmission unit 1375 transmits the MRB initiation message to the UE 1300.

In this case, the handover request acceptance message may include an MBMS continuity response message. For example, the MBMS continuity response message may indicate only whether the MBMS service can be supported. In another example, the MBMS continuity response message may include information regarding a cell, a CC, or a frequency to be used to provide the MBMS service to the UE 1300. In another example, the MBMS continuity response message may include information regarding a type of the MBMS service that the UE receives and information regarding a cell, a CC, or a frequency that can be supported by MBMS service in the target BS as shown in Table 1. In another example, the MBMS continuity response message indicates whether the target BS 1360 supports an MBMS service through an MRB. Also, in another example, when the target BS 1360 provides a closed subscriber group (CGS) cell in relation to a femto BS, the MBMS continuity response message may indicate whether a CSG cell supports an MBMS service. When the target BS 1360 provides a CSG cell, the target transmission unit 1375 may transmit the MBMS continuity response message to the source BS 1330.

All the foregoing functions may be performed by processors such as a microprocessor, a controller, a microcontroller, an ASIC (Application Specific Integrated Circuit) according to software coded to perform the functions or program codes. Designing, development, and implementation of the codes may be obvious to the skilled person in the art based on the description of the present invention.

The foregoing description of the preferred embodiments of the present invention is has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

1. A user equipment (UE), which transmits control information for continuity of a multimedia broadcast multicast service (MBMS) service, as a terminal performing handover from a source base station (BS) (or a source eNB) to a target BS (or a target eNB), the UE comprising:
a UE reception unit configured to receive a radio resource control (RRC) connection reconfiguration message from the source BS;
a UE processor configured to reconfigure an RRC connection of the UE on the basis of the RRC connection reconfiguration message, and generate an RRC connection reconfiguration complete message including at least one of a flag indicating whether an MBMS service is received and active MBMS service information indicating a type of the MBMS service; and
a UE transmission unit configured to transmit the RRC connection reconfiguration complete message to the target BS.

2. The UE of claim 1, wherein the UE reception unit receives an MBMS point-to-multipoint radio bearer (MRB) initiation message indicating that the MBMS service is provided through an MRB as a radio bearer for an MBMS, from the target BS.

3. The UE of claim 1, wherein the UE reception unit receives an MBMS information request message for requesting the flag or the active MBMS service information from the target BS,
the UE processors generates an MBMS information response message including the flag or the active MBMS service information, as a response with respect to the MBMS information request message, and
the UE transmission unit transmits the MBMS information response message to the target BS.

4. The UE of claim 3, wherein a type of the MBMS service is identified by a temporary mobile group identity (TMGI) with respect to the MBMS service.

5. A method for transmitting control information for continuity of a multimedia broadcast multicast service (MBMS) service by a user equipment (UE), which performs handover from a source base station (BS) to a target BS, the method comprising:
generating a measurement report regarding a source cell and a target cell;
transmitting the measurement report to the source BS;
receiving a radio resource control (RRC) connection reconfiguration message from the source BS;
reconfiguring an RRC connection on the basis of the RRC connection reconfiguration message;
generating an RRC connection reconfiguration complete message including at least one of a flag indicating whether an MBMS service is received and active MBMS service information indicating a type of the MBMS service; and
transmitting the RRC connection reconfiguration complete message to the target BS.

6. The method of claim 5, further comprising:
receiving an MBMS point-to-multipoint radio bearer (MRB) initiation message indicating that the MBMS service is provided through an MRB as a radio bearer for an MBMS, from the target BS.

7. The method of claim 5, further comprising:
receiving an MBMS information request message for requesting the flag or the active MBMS service information from the target BS;
generating an MBMS information response message including the flag or the active MBMS service information, as a response with respect to the MBMS information request message; and
transmitting the MBMS information response message to the target BS.

8. The method of claim 5, wherein a type of the MBMS service is identified by a temporary mobile group identity (TMGI) with respect to the MBMS service.

9. A target base station (BS) to provide continuity of a multimedia broadcast multicast service (MBMS) service with respect to user equipment (UE), the target BS comprising:
a target processor configured to generate an MBMS information request message for requesting at least one of information regarding whether the UE receives an MBMS service, information regarding a type of the MBMS service, and information regarding a cell in which the MBMS service is transmitted, from the UE, and to generate an MBMS point-to-multipoint radio bearer (MRB) initiation message indicating that the MBMS service is provided to the UE through an MRB as a bearer for an MBMS;
a target transmission unit configured to transmit the MBMS information request message or the MRB initiation message to the UE; and
a target reception unit configured to receive an MBMS information response message including at least one of information regarding whether the UE receives an MBMS service, information regarding a type of the MBMS service, and information regarding a cell in which the MBMS service is transmitted, from the UE, as a response with respect to the MBMS information request message.

10. The target BS of claim 9, wherein the target reception unit receives, from a source BS, a handover request message for requesting handover of the UE from the source BS to the target BS,
the target processor performs admission control of the handover, and
the target transmission unit transmits a handover request acceptance message indicating that the handover is accepted.

11. The target BS of claim 9, wherein the target reception unit receives a radio resource control (RRC) connection reconfiguration message indicating that the UE has completed reconfiguration of an RRC connection and including at least one of information regarding whether the UE receives the MBMS service and information regarding a type of the MBMS service, from the UE.

12. The target BS of claim 9, wherein a type of the MBMS service is identified by a temporary mobile group identity (TMGI) with respect to the MBMS service.

13. A method for providing continuity of a multimedia broadcast multicast service (MBMS) service by a target base station (BS) with respect to a user equipment (UE), the method comprising:
transmitting, to the UE, an MBMS information request message for requesting at least one of information regarding whether the UE receives an MBMS service, information regarding a type of the MBMS service, and information regarding a cell in which the MBMS service is transmitted from the UE;
receiving an MBMS information response message including at least one of information regarding whether the UE receives an MBMS service, information regarding a type of the MBMS service, and information regarding a cell in which the MBMS service is transmitted, from the UE, as a response with respect to the MBMS information request message; and
transmitting an MBMS point-to-multipoint radio bearer (MRB) initiation message indicating that the MBMS service is provided to the UE through an MRB as a bearer for an MBMS.

14. The method of claim 13, further comprising:
receiving a handover request message requesting handover of the UE from a source BS to the target BS;
performing admission control of the handover; and
transmitting a handover request acceptance message indicating that the handover is accepted to the source BS.

15. The method of claim 13, further comprising:
receiving a radio resource control (RRC) connection reconfiguration message indicating that the UE has completed reconfiguration of an RRC connection and including at least one of information regarding whether the UE receives the MBMS service and information regarding a type of the MBMS service, from the UE.

16. The method of claim 13, wherein a type of the MBMS service is identified by a temporary mobile group identity (TMGI) with respect to the MBMS service.
